(19) United States
(12) Patent Application Publication
(10) Pub. No.: US 2015/0305232 A1
(43) Pub. Date: Oct. 29, 2015

(54) Field Sprayer

(71) Applicant: Robert Bosch GmbH, Stuttgart (DE)

(72) Inventors: Benjamin Rosenbaum, Arnsberg (DE); Hubert Stratmann, Roggenburg (DE)

(21) Appl. No.: 14/694,001

(22) Filed: Apr. 23, 2015

(30) Foreign Application Priority Data
Apr. 23, 2014 (DE) 10 2014 207 595.5

(51) Int. Cl. A01C 23/04; A01M 7/00

(52) U.S. Cl. CPC A01C 23/047; A01M 7/0042

(57) ABSTRACT

A field sprayer, with a longitudinal axis oriented in a direction of travel, includes a rod assembly extending substantially transversely in relation to the longitudinal axis, and an actuator. An acceleration sensor attached to the rod assembly is configured to determine undesired tilt movement of the rod assembly, and the actuator enables the rod assembly to swivel about a swivel axis in order to compensate for the undesired tilt movement. The field sprayer further includes a control unit configured to operate the actuator so as to produce a counter tilt in order to compensate for disturbance variables affecting a tilt of the rod assembly which act on the rod assembly other than via a frame of the field sprayer. The control unit is further configured to operate the actuator during, and preferably at the start of an undesired tilt movement.

This application claims priority under 35 U.S.C. § 119 to patent application no. DE 10 2014 207 595.5, filed on Apr. 23, 2014 in Germany, the disclosure of which is incorporated herein by reference in its entirety.

The disclosure relates to a field sprayer.

### BACKGROUND

Such field sprayers are used to distribute liquids (in particular fertilizers or crop protection products) uniformly on fields. For this purpose, field sprayers have a boom appliance having two lateral arms, which are realized, for example, as rod assemblies, and disposed on which there is a multiplicity of nozzles for the liquid. Usually, the boom arms can be folded out laterally, and can attain working widths of up to 50 m.

Basically, in addition to the boom appliance comprising the nozzles, the field sprayers require a tank for the liquid, and a pump to convey the liquid to the nozzles. Differing known designs are attached, or mounted, hitched and self-driving field sprayers. Attached field sprayers are coupled to the lifting gear of a tractor, while mounted field sprayers are placed on the load platform of a multifunction vehicle. Hitched field sprayers are towed, as single-axle or dual-axle trailers, by a tractor.

When the field sprayer is in operation, the boom arms are supposed to be aligned such that they are always at the same distance from the ground, i.e., ideally, parallel to the ground. If, for example, it is necessary to travel over a protuberance on one side, the boom appliance has to be swiveled about a longitudinal axis of the field sprayer, and the side concerned has to be raised accordingly. When cornering (e.g. in the case of a turn at the end of the field) the field sprayer tilts because of the centrifugal force, with the result that the boom appliance on one side becomes lowered, such that it has to be raised accordingly on this side.

In order to achieve this, feedback control technology is used, the actuators of which swivel the boom appliance about the longitudinal axis, relative to a frame of the field sprayer. The greater the working width of the field sprayer, the more rapidly must the feedback control operate, and the more powerfully and rapidly must the actuators execute the correcting swivel movement.

The publication DE 10 2011 052 705 A1 discloses a hitched field sprayer having a turning rate sensor that is solid with the frame. This sensor is intended, by acting in combination with an onboard computer of the towing tractor, to identify when the hitched appliance is cornering (or turning) and to trigger a counter-movement in good time, before the boom appliance tilts. This is supplemented by distance sensors, provided at the ends of the boom appliance, the measurement data of which are also transmitted to the onboard computer of the tractor.

Since the “imminent” tilt of the field sprayer, and therefore the tilt of its boom appliance, can be deduced from the rotation about the vertical axis only in correlation with the current travel speed, it is essential in this case that the travel speed be taken into account.

A disadvantage of such field sprayers is that the rotations about the vertical axis that have to be sensed are comparatively small. A very sensitive turning rate sensor is therefore required. This applies, in particular, in the case of comparatively rapid cornering, in which a comparatively small rotation is already sufficient to produce a pronounced tilt of the boom appliance.

An additional disadvantage of such field sprayers is that disturbance variables are not taken into account. Thus, for example, the fill level of the tank, and therefore the weight of the field sprayer, have a considerable effect upon its centrifugal force, and therefore upon its tilt while cornering. Additional disturbance variable are the degree of fill of the tires and the hardness of the ground.

Finally, it has been found in practice that the boom arm on the inside of the bend does not tilt Downward—as stated in DE 10 2011 052 705 A1—but upward.

### SUMMARY

Against this, the disclosure is based on the object of creating a field sprayer that avoids the stated disadvantages. In particular, the fill level of the tank, the degree of fill of the tires and the hardness of the ground, which affect the tilt of the boom appliance, are to be taken into account in the correcting movement.

This object is achieved by a field sprayer as disclosed herein.

The disclosed field sprayer has a longitudinal axis oriented in the direction of travel, and has a boom appliance, comprising nozzles, that extends substantially transversely in relation to the longitudinal axis. The boom appliance may be a boom appliance that extends continuously on both sides, or a single-side boom arm. It may be a tube profile or, preferably, a rod assembly. The boom appliance can be swiveled about a swivel axis by means of at least one actuator, in order to adjust, and in particular to eliminate, lateral tilts. This is effected in dependence on the measurement signals of an acceleration sensor. The swivel axis may be approximately parallel to the longitudinal axis. According to the disclosure, the acceleration sensor is disposed directly on the boom appliance. By means of the acceleration sensor, an unwanted tilt movement is determined directly on the boom appliance, and therefore with all influencing factors being taken into account. According to the disclosure, therefore, it is possible also to compensate disturbance variables, affecting the tilt of the boom appliance, that act, not via a frame of the field sprayer, but directly on the boom appliance. A control unit operates the actuator so as to produce a counter-tilt. This is effected during the unwanted tilt movement, and ideally at the start thereof.

According to a first variant, the acceleration sensor may be a gyroscope, or turning rate sensor. The angular acceleration determined by it is preferably oriented about the longitudinal axis.

Additionally or alternatively, according to a second variant, the acceleration sensor may be realized to determine an approximately vertical translational acceleration, and consequently a movement of the affected portion of the boom appliance in the same direction. For this purpose, the acceleration sensor is disposed at a distance in relation to the swivel axis. The greater the distance of the acceleration sensor from the swivel axis or longitudinal axis, the more pronounced is the acceleration, perpendicularly in relation to the ground, that is sensed by the acceleration sensor, and the more defined the manner in which the feedback control of the control unit can respond.

In the case of the boom appliance extending continuously on both sides, a pair of acceleration sensors may be provided, which are disposed on both sides of the longitudinal axis, on both arms.

It is particularly preferred if the acceleration sensor is disposed on an outer end portion of the boom appliance. The measurement signal of the acceleration sensor, and the quality of feedback control, are thus optimized in respect of absence of noise. In the case of the boom appliance extending continuously on both sides, the two acceleration sensors are disposed on the respective outer end portions of the two arms.

Since the actuator requires a support, the field sprayer preferably has a frame. Attached to the latter, in the case of a particularly preferred development, is a further acceleration sensor, which is solid with the frame. This acceleration sensor can sense accelerations that act firstly upon the frame before being transmitted to the boom appliance. This time delay may result from elastic deformation of the frame, a suspension between the frame and the boom appliance, and/or the boom appliance itself. The control unit can thus calculate the unwanted tilt of the boom appliance in advance. In the ideal case, the actuator can set the counter-tilt in the time period in which the boom appliance would also execute the unwanted tilt.

The acceleration sensor that is solid with the frame may also enable further functions to be realized, such as a stability program (ESP), shifting of a center of gravity in the case of road travel, speed limitation or steering angle limitation on the tractor or on a self-driving field sprayer. The speed limitation or steering angle limitation is activated, in particular, in the case of a high center of gravity of the field sprayer, in order to prevent it from overturning.

If the acceleration sensor that is solid with the frame and the control unit are disposed on a common circuit board, there is no need for connectors and cables between the two components.

The acceleration sensor of the boom appliance, or in particular the acceleration sensor that is solid with the frame, may be a six-axis acceleration sensor that, in addition to the translational accelerations of the three spatial axes, also and senses the three corresponding rotary accelerations.

The acceleration sensor of the boom appliance, or in particular the acceleration sensor that is solid with the frame, may be a nine-axis acceleration sensor that, in addition to the translational and the rotary accelerations of the three spatial axes, has three earth magnetic-field sensors.

A central distance sensor (in particular, ultrasonic sensor) may be disposed on the boom appliance. By combined action with the at least one acceleration sensor, the distance in relation to the ground can be adjusted with a high degree of precision.

Two outer distance sensors (in particular, ultrasonic sensors) may be disposed on the boom appliance. In the case of large working widths of the boom appliance, in particular, a further distance sensor may be disposed in each case between the respective outer distance sensor and the longitudinal axis. Ground irregularities can thereby also be compensated with a high degree of precision. Furthermore, the distance sensors can verify the plausibility of the results of the at least one acceleration sensor. Conversely, the at least one acceleration sensor can effect plausibility verification of the distance sensors, for instance in order not to continually alter the setting of the boom appliance when stones or plants of unequal height are sensed.

If the field sprayer according to the disclosure is realized as a hitched field sprayer, it is particularly preferred if it has two axles and with an electronic forced steering. Track damage to the field plants during cornering can thus be reduced. Owing to the forced steering, the curve radius, and therefore the centrifugal force of the field sprayer, are increased, the tractor cornering remaining the same, such that the unwanted tilt of the boom appliance is amplified. In the case of this development, the benefit and importance of the at least one acceleration sensor according to the disclosure are increased.

In order to achieve a large working width with, at the same time, suitability for road travel, it is preferred if the boom appliance has at least two fold points on each arm, and has an actuator at each fold point. A particularly large working width of the field sprayer is thereby achieved, such that the benefit and importance of the at least one acceleration sensor according to the disclosure are increased.

### BRIEF DESCRIPTION OF THE DRAWINGS

Various features of a field sprayer according to the disclosure are described in the following drawings.

In the drawings:

FIG. 1 shows an exemplary embodiment of a field sprayer, in a top view, and

FIG. 2 shows the field sprayer according to FIG. 1, in a view from behind.

### DETAILED DESCRIPTION

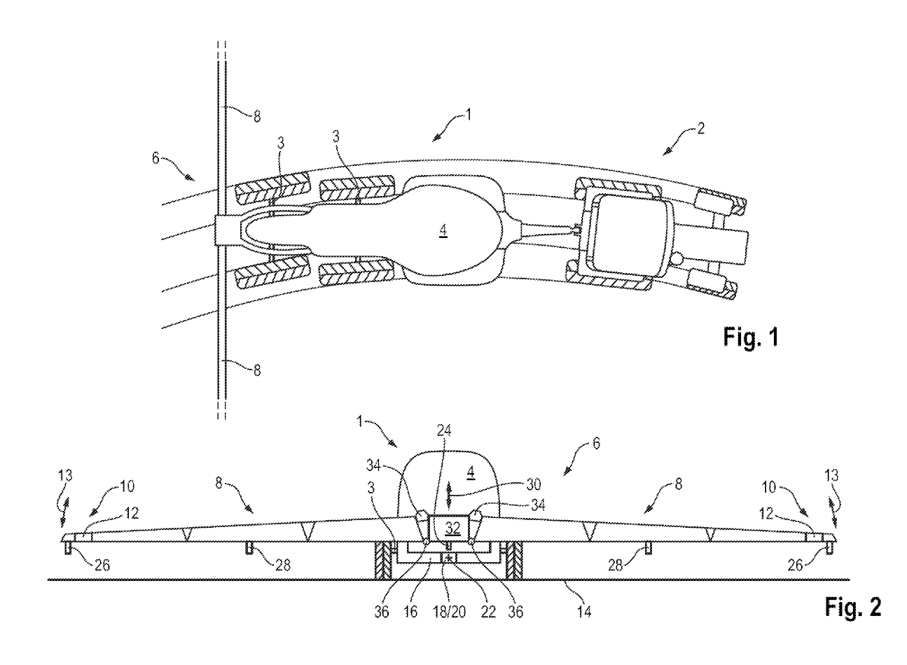

FIG. 1 shows the exemplary embodiment of the field sprayer 1 according to the disclosure, which is realized as a trailer having two steerable axles 3, and which is hitched to a tractor 2. The field sprayer 1 has a tank 4, the liquid of which is to be distributed uniformly on the ground. For this purpose, coupled to the rear of the field sprayer 1 there is a boom appliance 6, the two arms 8 of which extend transversely in relation to the direction of travel of the tractor 2 and of the field sprayer 1. In this case, the arms 8 are represented only partially in FIG. 1.

Disposed on the underside of the two arms 8 there is a multiplicity of nozzles (not shown), a pump (not shown) conveying the liquid out of the tank 4 to the nozzles, whereby the liquid is distributed on the ground.

Owing to the two axles 3 provided with an electronic forced steering, the hitched field sprayer 1 substantially follows the track of the tractor 2 as it corners. Consequently, the curve radius of the field sprayer 1 is increased in comparison with non-steered axles, the speed of the tractor 2 remaining the same, causing the centrifugal force on the field sprayer 1 to be increased. The field sprayer 1 consequently tilts outward, causing an unwanted tilt of the boom appliance 8.

FIG. 2 shows the field sprayer 1 in a view from behind. This shows the two arms 8, including their end portions 10. Cornering causes the end portion 10 of the arm 8 on the outside of the bend to be lowered, as indicated by the double arrow 13, while the end portion 10 of the arm on the inside of the bend is raised, as indicated by the double arrow 13.

Attached to both end portions 10 is a respective acceleration sensor 12 that senses, in particular, upward and downward movements, i.e. movements perpendicular to the ground 14. Moreover, a control unit 18 and a six-axis acceleration sensor 20 are disposed, on a common circuit board, on a frame 16 of the field sprayer 1, a first spatial axis of the six-axis acceleration sensor 20 being disposed along a longitudinal axis 22 of the field sprayer 1, and the other two spatial axes being disposed perpendicularly in relation thereto. The six-axis acceleration sensor 20 can therefore sense accelerations, and thus movements of the frame 16 of the field sprayer 1, even before these are transmitted to the boom appliance 6. This delayed transmission of movements of the frame 16 to the boom appliance 6 is due to elasticities, in particular in the coupling of the boom appliance 6 to the frame. The two acceleration sensors 12 directly attached to the boom appliance 6 therefore each communicate the unwanted tilt movements of the boom appliance 6, with wind gusts, for example, being taken into account. In this case, an unwanted tilt movement 13 is first required before the control unit 18 can respond. On the other hand, the six-axis acceleration sensor 20 attached to the frame 16 can only sense influencing factors that are transmitted to the boom appliance 6 via the frame 16. In this case, this sensor 20 has the advantage that it can transmit measurement signals to the control unit 18 before the boom appliance 6 commences the unwanted tilt movement 13.

Finally, there are disposed a central distance sensor 24, two outer distance sensors 26, and two further distance sensors 28 approximately in a central region of the respective arm, which are realized as ultrasonic sensors, and which likewise transmit their measurement signals to the control unit 18. These distance sensors 24, 26, 28 sense, on the one hand, the distance of the two arms 8 in relation to the ground 14, with irregularities of the ground 14 being sensed at the same time.

In dependence on the transmitted measurement signals of all sensors 12, 20, 24, 26, 28, on the one hand a lifting means (not shown) is operated, by means of which the height of a central portion 32 of the boom appliance 6 can be set relative to the frame 16, as indicated by the double arrow 30. In addition, the control unit 18 operates two actuators 34, by means of which the tilt of a respective arm 8 can be set, as indicated by the double arrow 13. For this purpose, each arm 18 is swiveled about an assigned swivel axis 36, the orientation of which is approximately parallel to the longitudinal axis 22 of the field sprayer 1.

Disclosed is a field sprayer having a longitudinal axis oriented in the direction of travel, and having a rod assembly extending substantially transversely in relation to the longitudinal axis.

The rod assembly can be swiveled about a swivel axis by means of an actuator, in order to compensate unwanted tilt movements. This is effected in dependence on the measurement signals of an acceleration sensor attached directly to the rod assembly. By means of the acceleration sensor, an unwanted tilt movement is determined directly on the rod assembly, and therefore with all influencing factors being taken into account. It is thus possible also to compensate disturbance variables, affecting the tilt of the rod assembly, that act on the rod assembly other than via a frame of the field sprayer. A control unit operates the actuator so as to produce a counter-tilt. This is effected during the unwanted tilt movement, and ideally at the start thereof.

### LIST OF REFERENCES

1 hitched field sprayer
2 tractor
3 axle
4 tank
6 boom appliance
8 arm
10 end portion
12 acceleration sensor
13 double arrow of tilt movement
14 ground
16 frame
18 control unit
20 six-axis acceleration sensor
22 longitudinal axis
24 central distance sensor
26 outer distance sensor
28 further distance sensor
30 double arrow
32 middle portion
34 actuator
36 swivel axis

What is claimed is:

1. A field sprayer, comprising:
a boom appliance that extends substantially transversely in relation to a direction of travel, the boom appliance configured to swivel about a swivel axis;
an actuator that is operable to swivel the boom appliance about the swivel axis; and
an acceleration sensor that is disposed on the boom appliance, and that is configured to determine a tilt movement of the boom appliance.

2. The field sprayer according to claim 1, wherein the acceleration sensor includes a turning rate sensor or a gyroscope.

3. The field sprayer according to claim 1, wherein the acceleration sensor is disposed at a distance in relation to the swivel axis, and is further configured to determine an approximately vertical translational acceleration.

4. The field sprayer according to claim 3, wherein the acceleration sensor is disposed on an outer end portion of the boom appliance.

5. The field sprayer according to claim 1, further comprising:
a frame; and
a further acceleration sensor that is attached to the frame so as to be solid with the frame.

6. The field sprayer according to claim 5, further comprising a control unit configured to operate the actuator with reference to measurement signals generated by the acceleration sensor and the further acceleration sensor, wherein the further acceleration sensor is disposed on a common circuit board with the control unit.

7. The field sprayer according to claim 1, wherein the acceleration sensor is a six-axis acceleration sensor.

8. The field sprayer according to claim 1, wherein the acceleration sensor is a nine-axis acceleration sensor.

9. The field sprayer according to claim 1, further comprising a central distance sensor disposed on the boom appliance.

10. The field sprayer according to claim 1, further comprising two outer distance sensors disposed on the boom appliance.

11. The field sprayer according to claim 1, further comprising two axles, the field sprayer having an electronic forced steering, and being configured as a hitched field sprayer.
